(19) United States
(12) Patent Application Publication
(10) Pub. No.: US 2022/0079259 A1
(43) Pub. Date: Mar. 17, 2022

(54) Thumb Assistance Tool

(71) Applicants: Deborah Bush, Enterprise, AL (US); Faith Meadows, Enterprise, AL (US)

(72) Inventors: Deborah Bush, Enterprise, AL (US); Faith Meadows, Enterprise, AL (US)

(21) Appl. No.: 17/474,449

(22) Filed: Sep. 14, 2021

Related U.S. Application Data
(60) Provisional application No. 63/078,116, filed on Sep. 14, 2020.

(51) Int. Cl. A41D 13/08

(52) U.S. Cl. CPC A41D 13/087; A41D 2400/48

(57) ABSTRACT

A thumb guard device is provided. The device includes a solid elongated body. The solid elongated body is shaped like a finger or thumb. The elongated body varies is length and shape to accommodate for different usages. The solid elongated body is composed of a rigid plastic material to engage with a desired surface or object. The device includes an aperture to receive a keyring or any similar connector to mount the device to an object. In one embodiment, the device may be placed within the user's hand. In one embodiment, the device may also be placed over the finger or thumb of a user. The device further includes photoluminescent properties. The photoluminescent properties provide the user with a light source when it is used in dark spaces. The device may protect the thumb of the wearer when activating a difficult push-buttons or otherwise applying force to a surface.

### CROSS REFERENCE TO RELATED APPLICATIONS

This application claims the benefit of U.S. Provisional Application No. 63/078,116 filed on Sep. 14, 2020. The above identified patent application is herein incorporated by reference in its entirety to provide continuity of disclosure.

### BACKGROUND OF THE INVENTION

The present invention relates to a thumb guard tool. More specifically, the present invention provides a thumb guard tool that assists users in applying force to a seat belt buttons or a car seat buttons to release the desired latch. Moreover, the thumb guard tool will enable a user to apply enough force to a desired surface without risking damage or injury to their own fingers and thumb.

Seatbelts and car seats provide protection to individuals and children while they are sitting in an automobile. Such protective devices include a securing mechanism that limits the individual's chances from suffering a major injury if the automobile were to be in an accident. More often than not in order for an individual to be released from a seat belt or car seat, the button needs to be engaged in order to release the latch. Since seatbelts and car seats provide such an important function to the individuals that they are protecting, to release the latch and free the individual from such protective devices can require a significant amount of force.

For individuals that suffer from a disability or a degenerative disease it may be difficult to apply the necessary amount of force to the desired latch to release themselves or another from a seat, belt or car seat. For example. If an Individual is suffering from arthritis in their hands, they may lose the ability to use their fingers in a situation where their fingers must apply a high amount of force against another object. Such an individual may have frail and weak fingers that cannot withstand the appropriate amount of force needed to achieve the objective. Moreover, an individual suffering from such a disease may not be able to contort their fingers in such a way that the can even direct an appropriate force to a specific area on another object.

Some individuals, mostly women, enjoy maintaining longer fingernails for aesthetic reasons. For those individuals who do maintain longer fingernails it can be difficult to apply a force against an object with their fingers. Specifically, the fingernails can be obstacles in which limit the individual's ability to position their fingers in a desirable configuration. In instances where individuals with longer fingernails do apply a substantial force against an object, their fingernails could end up being damaged or broken. When an individual's fingernail is broken it can be uncomfortable for the individual since there is a high number of nerve endings connected to the base of their fingernails. Similarly, individuals with longer fingernails may experience the same restrictions in their ability to apply force against an object with their fingers as somebody who is suffering from a disability or degenerative disease.

When an individual that has an inability to use their fingers to apply a force to an object, they can be left in a precarious position. For example, if an adult is in an automobile with a small child, the small child may be placed within a car seat and the adult secured to their seat via a seat belt. If the adult lacks the ability to apply force to an object, with their fingers, then the small child, or possibly both the adult and the small child, maybe trapped in the automobile until they receive assistance from a third party. Any unfortunate instances where it is necessary to escape from an automobile quickly and swiftly, may leave a party that is unable to unlatch a seat belt or car seat in a dangerous position. Specifically, having to rely on a third party to arrive and provide the proper assistance to unlatch the seat belt or car seat may take too much time for the individual strapped to the seat belt to escape in a necessary amount of time.

Beyond the inability to unlatch a protective device within an automobile, individuals who cannot apply force to an object with their fingers may be hampered in other aspects as well. For example, if an Individual lives in an apartment complex that requires the use of an elevator, the elevator may require the individual to apply force to the elevator buttons to both gain access to the elevator and select the desired floor in which they need the elevator to arrive. Therefore, an individual can be in a wide variety of situations that require them to use their fingers and apply a significant force against an object to achieve a necessary function. Without the ability to apply the necessary force, an individual will be unable to perform mundane, yet necessary tasks to go throughout their day.

Due to the spread of highly infectious diseases, individuals may desire not to place their fingers on publicly used appliances or equipment. To protect oneself against contracting such contagious diseases, it is important to limit the contact, one has with publicly used appliances or equipment. However, there are instances where the individual must use a public appliance or equipment to utilise or access necessities. These individuals can limit, their exposure two such contagious diseases by using tools in which limit their physical contact with such appliances or equipment.

Therefore, there is a defined need amongst the known prior art references for a thumb guard tool that will allow users to apply a necessary force upon an object or a surface, either privately or publicly used, without having to use their own fingers.

### SUMMARY OF THE INVENTION

In view of the foregoing disadvantages inherent in the known types of thumb guards now present in the known art, the present invention provides a new thumb guard that may be held in a user's hand or placed over a user's thumb that includes a pair of apertures for receiving a key ring or similar connector and possesses photoluminescent properties.

It is therefore an object of the present invention to provide a thumb guard that allows a user to apply a needed force to an object without risking injury or damage to their thumb or fingers. The thumb guard has multiple embodiments that allows a user to operate the device. Whether the thumb guard is placed in the user's hand or placed upon the user's thumb, the thumb guard will enable a user to engage with a desired object or surface. Specifically, the thumb guard will allow the user to apply the appropriate amount of force to the seat buckle or button to release the strap. This alternative method to disengage a seat belt or any other push button locking device without using one's real fingers will limit the chances the user will sustain any damage to their fingers from having to apply the necessary force thereon. Moreover, the alternative method allows an Individual who lacks the necessary dexterity to also release the latch effectively on their seatbelt. Additionally, for individuals that have longer fingernails they will not have to risk breaking the nail from exposing the nail to such high force when using their fingers or thumb to engage the object or surface.

Another aspect of the present invention is to allow a user to protect against any disease transmittable through physical contact with a publicly used surface or object. When taking public transportation, individuals will regularly have to use the safety belts and seat buckles that are used by the previous passenger. Additionally, when the individual is pressing buttons that operate doors or elevators, they typically must directly place their finger upon the surface. These publicly used items and surfaces may contain a high number of bacteria due to the regular use from people. When directly contacting these surfaces, the bacteria may transfer to an individual and result in the individual contracting an illness. Providing a user with an alternative means to engage the public surface will limit the chances that the bacteria transfers to the individual and ultimately results in an illness.

Yet another aspect of the present invention is to allow users to use the device even in dark or dimly lit areas. When in a car at night, it may be difficult to locale the exact seat belt or car seat button that needs to be disengaged to release an individual. The photoluminescent properties of the object, will provide an illumination that will help a user operate the present invention even when they lack the necessary light to view the desired objects and areas.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of an embodiment of the thumb device secured to a key chain.

FIG. 1B shows a perspective view of an embodiment of the thumb device secured to a key chain in use.

FIG. 2A shows a perspective view of an alternative embodiment of the thumb device secured to a key chain.

FIG. 2B shows a perspective view of an alternative embodiment of the thumb device secured to a key chain in use.

FIG. 3A shows a perspective view of an alternative embodiment of the thumb device placed over a user's thumb.

FIG. 3B shows a perspective view of an alternative embodiment of the thumb device placed upon a user's thumb.

### DETAILED DESCRIPTION OF THE INVENTION

Reference is made herein to the attached drawings. Like reference numerals are used throughout the drawings to depict like or similar elements of a thumb assistance device. The figures are intended for representative purposes only and should not be limiting in any respect.

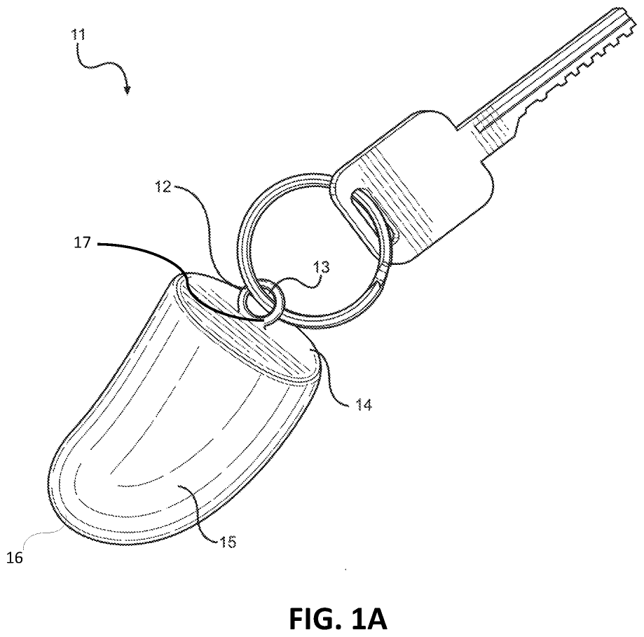

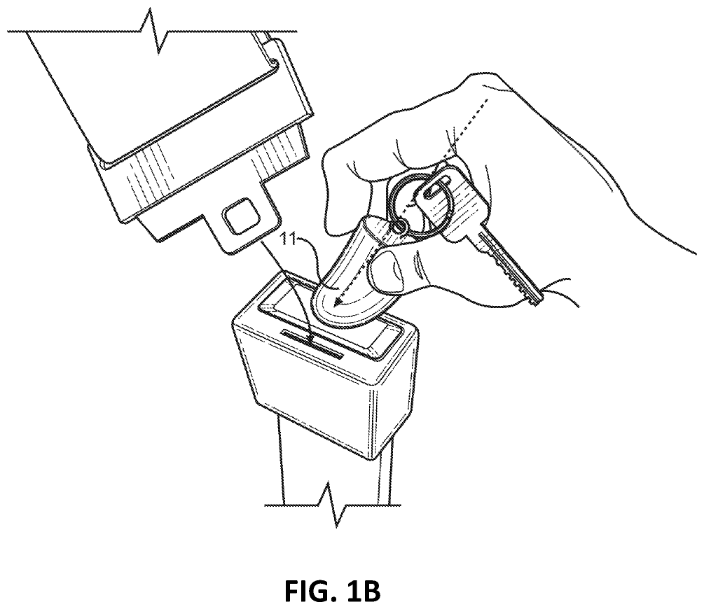

FIG. 1A shows a perspective view of an embodiment of a thumb device secured to a key chain. The thumb device 11 comprises a solid elongated body 15. The solid elongated body 15 includes a working end 16 and an attaching end 12. The working end 16 opposes the attaching end 12 on the solid elongated body 15. The working end 16 is rounded and slightly curved to provide a reduced contact surface area and increase the relative force applied by user when the device is in use. The attaching end 12 is a flat surface 14. The attaching end 12 encloses the solid elongated body 15. A protrusion 17 perpendicularly extends outwardly from the flat surface 14 of the attaching end. The protrusion 17 is centrally located on the attaching end 12. An aperture 13 extends through the protrusion 17. The aperture 13 may be engaged by a keychain ring or another fastener. The aperture 13 allows the thumb device 11 to remain attached to the keychain or any other adaptable attachment.

In one embodiment, the solid elongated body 15 and the working end 16 are composed of a rigid material. The rigid property of the thumb device 11 permits the user to apply the appropriate amount of force to press against an object or surface. In one embodiment, the solid elongated body 15 is composed of a photoluminescent material. The photoluminescent material allows the thumb device 11 to illuminate in the dark. The photoluminescent material provides the user with convenience to locate and use the thumb device 11 in dark areas.

FIG. 1B shows a perspective view of an embodiment of a thumb device secured to a key chain in use. in use, a user will place the thumb device 11 in their hand. In the shown embodiment, the thumb device 11 is coupled with a keychain. The user will then orient the thumb device 11 in such a way that the working end is directed towards the desired seat buckle or button. The thumb device 11 will engage with the desired seat buckle or button. When the appropriate amount of force is applied to the seat buckle or button, the seat buckle or button will release the latch. This will allow for the user to remove the seat belt strap from their person, from another's body, or from a car seat without having to use their own fingers. The alternative method for a user to disconnect a seat belt by using the thumb device 11 will limit the chances the user will sustain any damage to their fingers from having to apply the necessary force thereon and allow individuals who lack the necessary dexterity to also release their seatbelt effectively.

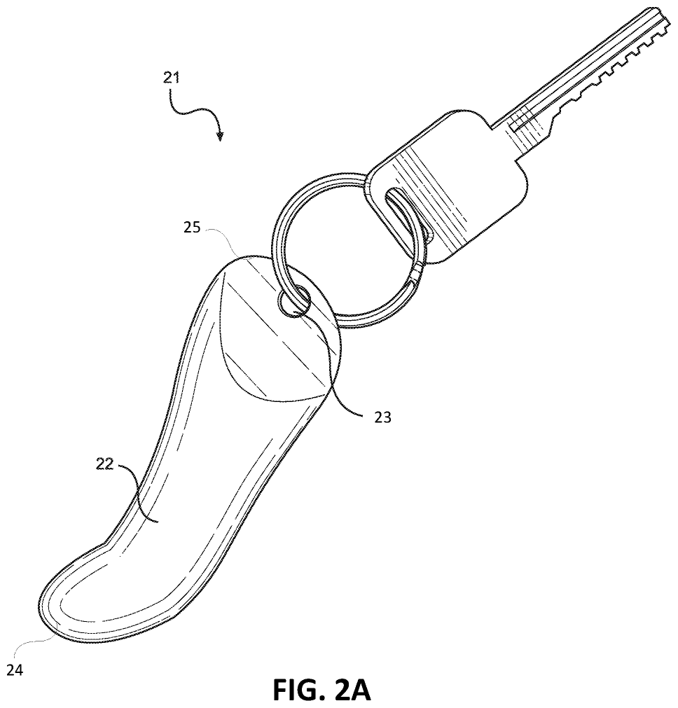

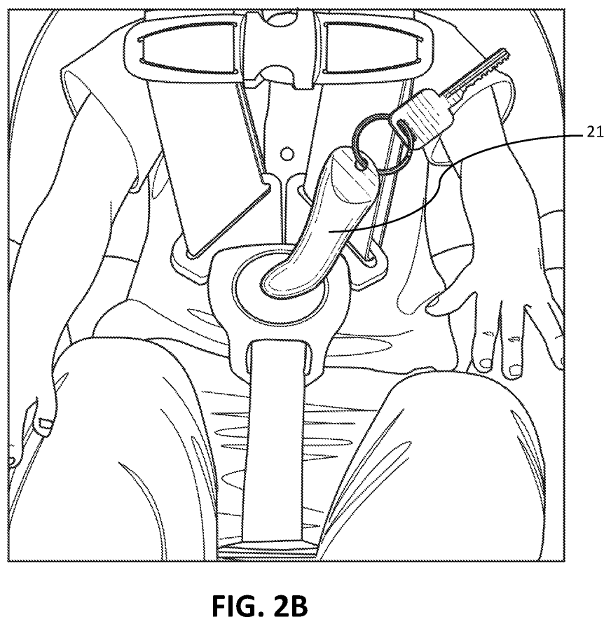

FIG. 2A shows a perspective view of an alternative embodiment of a thumb device secured to a key chain. The thumb device 21 comprises a solid elongated body 22. The solid elongated body 22 includes a working end 24 and an attaching end 25. The working end 24 is opposing the attaching end 25 on the solid elongated body 21. The working end 24 is rounded and has a slight curvature. The attaching end 25 tapers outwardly and away from the sold elongated body 22. The attaching end 25 encloses the solid elongated body 22. An aperture 23 is disposed on the attaching end 25. Moreover, the aperture 23 is configured to engage a keychain ring or another fastener to secure the thumb device 21 to an object. The aperture 23 allows the thumb device 21 to remain attached to the keychain or any other adaptable attachment for ease of access for the user. The solid elongated body 21 of the thumb device 21 allows for users to reach desired objects or surfaces that may require extra length.

FIG. 2B shows a perspective view of an alternative embodiment of a thumb device secured to a key chain in use. In use, a user will place the thumb device 21 in their hand. In the shown embodiment, the thumb device 21 is coupled with a keychain. The user will then orient the thumb device 21 in such a way that the working end is directed towards the desired seat buckle or button. The thumb device 21 will engage with the desired seat buckle or button. When the appropriate amount of force is applied to the seat buckle or button, the seat buckle or button will release the strap. This will allow for the user to remove the seat belt strap from their person, from another's body, or from a car seat without having to use their own fingers. The alternative method for 3 user to disconnect a seat belt by using the thumb device 21 will allow users to reach desired objects or surfaces that may require extra length without sustain any damage to their fingers.

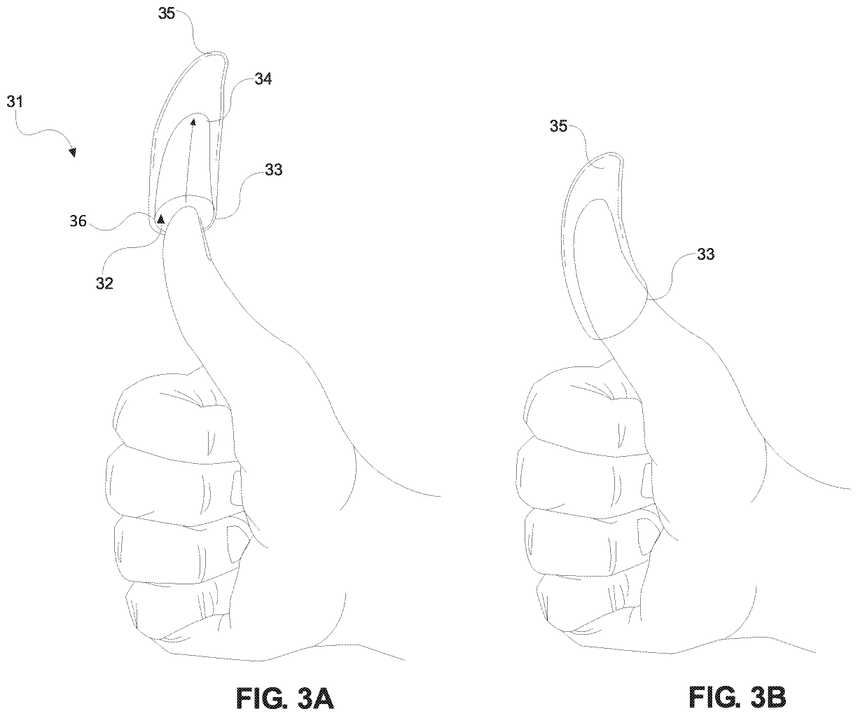

FIG. 3A shows a perspective view of an alternative embodiment of a thumb device placed over a user's thumb. The thumb device 31 comprises a rounded end 35 and a flexible perimeter wall 36. The flexible perimeter wall 36 extends downwardly from the rounded end 35, defining a cylindrical body 34. The cylindrical body 34 contains a slight curvature. The flexible perimeter wall 36 includes an open lower end 33, defining 3n interior volume 32. The open lower end 33 is on the opposing side of the rounded end 35. The interior volume 32 tapers inwardly from the open lower end 36 towards the rounded end 35.

A user will insert their thumb into the thumb device 31 through the open lower end 33. The thumb device 31 encases the user's thumb. The user's thumb will be placed within the interior volume 32. The flexible perimeter wall 36 provides the user with the ability to maneuver their thumb in the desired direction while the thumb device 31 is in use. In one embodiment, the thumb device 31 is composed of a photoluminescent material. The photoluminescent material allows the thumb device 31 to illuminate in the dark. The photoluminescent material provides the user with convenience to locate and use the thumb device 31 in dark areas.

FIG. 3B shows a perspective view of an alternative embodiment, of a thumb device placed upon a user's thumb. In use, the thumb device will be placed onto the user's thumb. The open lower end 33 encircles the user's thumb, when the thumb is within the interior volume. In one embodiment, the rounded end 35 is composed of a rigid plastic material. In another embodiment, the rounded end 35 is composed of a rigid rubber material. The rigid property of the thumb device permits the user to apply the appropriate amount of force to press against an object without destroying the integrity of the thumb device. When the thumb device is placed on the users thumb the rounded end 35 will engage with the desired object or surface. When the appropriate amount of force is applied to the object or surface, the object, or surface will be engaged or disengaged. The thumb device will protect the user's thumb from any injury or strain as a result of having to apply the necessary force thereon.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and ail equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A thumb assistance tool, comprising:
a solid elongated body;
wherein the solid elongated body comprises a working end and an attaching end;
wherein the working end is rounded;
wherein the attaching end encloses the solid elongated body;
a protrusion disposed on the attaching end; and
wherein the protrusion includes an aperture thereon.

2. The thumb assistance tool of claim 1, wherein the solid elongated body is composed of a photoluminescent material.

3. The thumb assistance tool of claim 1, wherein the protrusion is centrally located on the attaching end.

4. The thumb assistance tool of claim 1, wherein the aperture may engage with a keychain or any other adaptable attachment.

5. A thumb assistance tool, comprising:
a solid elongated body;
wherein the solid elongated body comprises a working end and an attaching end;
wherein the working end is rounded and curved;
wherein the attaching end tapers away from the solid elongated body; and
an aperture disposed through the attaching end.

6. The thumb assistance tool of claim 5, wherein the solid elongated body is composed of a photoluminescent material.

7. The thumb assistance tool of claim 5, wherein the aperture is configured to engage a keychain.

8. A thumb assistance tool, comprising:
a rounded end;
a flexible perimeter wall extending downwardly from the rounded end, defining a cylindrical body;
the flexible perimeter wail includes an open lower end, defining an interior volume;
the open lower end is opposing the rounded end; and
wherein the interior volume tapers inwardly from the open lower end towards the rounded end.

9. The thumb assistance tool of claim 8, wherein the solid elongated body is composed of a photoluminescent material.

10. The thumb assistance tool of claim 8, wherein the open lower end and the interior volume are configured to receive a thumb or a finger.
